(19) United States
(12) Patent Application Publication
(10) Pub. No.: US 2020/0401710 A1
(43) Pub. Date: Dec. 24, 2020

(54) SYSTEM AND METHOD FOR CENSORING AGE-INAPPROPRIATE CONTENT IN REAL-TIME

(71) Applicant: Citrix Systems, Inc., Burlington, MA (US)

(72) Inventors: DAOWEN WEI, Nanjing (CN); Jian Ding, Nanjing (CN); Hengbo Wang, Nanjing (CN)

(21) Appl. No.: 16/546,739

(22) Filed: Aug. 21, 2019

(30) Foreign Application Priority Data
Jun. 21, 2019 (CN) PCT/CN2019/092400

(51) Int. Cl. G06F 21/62; G06K 9/00; G06T 11/60; G06F 3/14

(52) U.S. Cl. CPC G06F 21/62; G06K 9/00288; G06K 2009/00322; G06F 3/14; G06T 11/60

(57) ABSTRACT

Described embodiments provide a method, computer program product, and computer system for identifying a user that is proximate to a computing device. The age type of the user may be identified. It may be determined that content displayed on the computing device is not permitted for the age type of the user. Display of the content may be altered on the computing device based upon, at least in part, determining that the content displayed on the computing device is not permitted for the age type of the user.

### RELATED APPLICATION

This application claims priority to PCT Application No. PCT/CN2019/092400, filed on 21 Jun. 2019, the entire contents of which are incorporated herein by reference.

### BACKGROUND

Computing devices may be used for many things, such as work, education and entertainment. With various types of content readily available to end users of all age groups, it may be possible that the content being viewed is not age-appropriate.

### BRIEF SUMMARY OF DISCLOSURE

In one example implementation, a method, performed by one or more computing devices, may include but is not limited to identifying a user that is proximate to a computing device. The age type of the user may be identified. It may be determined that content displayed on the computing device is not permitted for the age type of the user. Display of the content may be altered on the computing device based upon, at least in part, determining that the content displayed on the computing device is not permitted for the age type of the user.

One or more of the following example features may be included. Altering display of the content may include one of masking the content and replacing the content. It may be identified that the user is no longer proximate to the computing device, and alteration of the content displayed on the computing device may be reversed based upon, at least in part, identifying that the user is no longer proximate to the computing device. A sampling interval may be changed based upon, at least in part, identifying that the user that is proximate to the computing device. A bitmap may be constructed with a size equal to coordinates of at least a portion of the content displayed. The bitmap may be updated at the coordinates of at least the portion of the content displayed to alter the display. Identifying the age type of the user may include performing facial analysis on the user.

In another example implementation, a computing system may include one or more processors and one or more memories configured to perform operations that may include but are not limited to identifying a user that is proximate to a computing device. The age type of the user may be identified. It may be determined that content displayed on the computing device is not permitted for the age type of the user. Display of the content may be altered on the computing device based upon, at least in part, determining that the content displayed on the computing device is not permitted for the age type of the user.

One or more of the following example features may be included. Altering display of the content may include one of masking the content and replacing the content. It may be identified that the user is no longer proximate to the computing device, and alteration of the content displayed on the computing device may be reversed based upon, at least in part, identifying that the user is no longer proximate to the computing device. A sampling interval may be changed based upon, at least in part, identifying that the user that is proximate to the computing device. A bitmap may be constructed with a size equal to coordinates of at least a portion of the content displayed. The bitmap may be updated at the coordinates of at least the portion of the content displayed to alter the display. Identifying the age type of the user may include performing facial analysis on the user.

In another example implementation, a computer program product may reside on a computer readable storage medium having a plurality of instructions stored thereon which, when executed by one or more processors, may cause the one or more processors to perform operations that may include but are not limited to identifying a user that is proximate to a computing device. The age type of the user may be identified. It may be determined that content displayed on the computing device is not permitted for the age type of the user. Display of the content may be altered on the computing device based upon, at least in part, determining that the content displayed on the computing device is not permitted for the age type of the user.

One or more of the following example features may be included. Altering display of the content may include one of masking the content and replacing the content. It may be identified that the user is no longer proximate to the computing device, and alteration of the content displayed on the computing device may be reversed based upon, at least in part, identifying that the user is no longer proximate to the computing device. A sampling interval may be changed based upon, at least in part, identifying that the user that is proximate to the computing device. A bitmap may be constructed with a size equal to coordinates of at least a portion of the content displayed. The bitmap may be updated at the coordinates of at least the portion of the content displayed to alter the display. Identifying the age type of the user may include performing facial analysis on the user.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of an example network environment according to one or more example implementations of the disclosure;

FIG. 2 is an example diagrammatic view of a computing device of FIG. 1 according to one or more example implementations of the disclosure;

FIG. 3 is an example flowchart of a display process according to one or more example implementations of the disclosure; and

FIG. 4 is an example diagrammatic view of transient and static regions of a bitmap according to one or more example implementations of the disclosure.

Like reference symbols in the various drawings may indicate like elements.

### DETAILED DESCRIPTION

With children growing up in the digital age, it may be a challenge for parents to get their children to use the internet safely and guarantee the right content is being accessed. For example, while online computer exploration may open up a world of possibilities for children by expanding their horizons and exposing them to different cultures and ways of life, they can also be exposed to dangers, like age-inappropriate images, videos, as well as violent video games. Some children, especially adolescents, are sometimes interested in and curious about sexuality, and sexually explicit media resources. Additionally, even if age-inappropriate material is not purposefully sought out, an age-inappropriate website may mistakenly be visited, or some age-inappropriate online advertisements may still be delivered to their digital space.

For example, age-inappropriate advertisements may arrive unexpectedly on a shared user device or workspace. For instance, both parents and children may share a computing device or workspace, like a virtual desktop/app in a cloud computing environment. In such a scenario, all of the user behaviors, history records and access cookies may be detected and uploaded to third parties for further analysis, so that online advertisements can be intelligently delivered. However, since it may be difficult to distinguish the different users on a shared user device or workspace, some adult advertisements may arrive unexpectedly when children are using the shared user device or workspace, which may also be embarrassing to the family members. A similar situation may arise with a presenter in a class or lecture. As another example, children may arrive unexpectedly when an adult is browsing information that may not be appropriate to children.

Some techniques may be used to help mitigate the risk of a child viewing age-inappropriate material. For example, complying with some state laws, some software companies or content distributors may request that the user verify their age when setting up their accounts, or viewing a webpage, to ensure the user is old enough to view the content. However, this technique can be easily circumvented by lying about one's age. Parents may also attempt to use a firewall to block questionable sites, or leverage official rating systems to block webpages or other content, but even these techniques are not ideal. For instance, the whole webpage or sites are generally blocked or masked with bigger granularity, while parents may need a more accurate masking with smaller granularity (e.g., like one or several rectangle areas with age-inappropriate content embedded in a webpage.) Thus, it may be very difficult for parents to monitor and audit the content their children are viewing. Although parents may review website histories at a later time, this does not prevent the viewing of age-inappropriate content until it is too late.

Accordingly, as will be discussed in greater detail below, the present disclosure may enable a minor friendly digital space and in real-time, keep children away from those age-inappropriate images, videos and games based on, e.g., user biometric features to estimate/verify the user's age, rather than relying on the user's honesty. This may be accomplished using, for example, deep learning techniques that may not only recognize the user's age when they are in front of the computer screen, but also may blank or replace age-inappropriate content with small granularity by, for instance, performing incremental content checking and requesting image analysis by delta change on the user group level to achieve real-time blanking/un-blanking/replacement of age-inappropriate content.

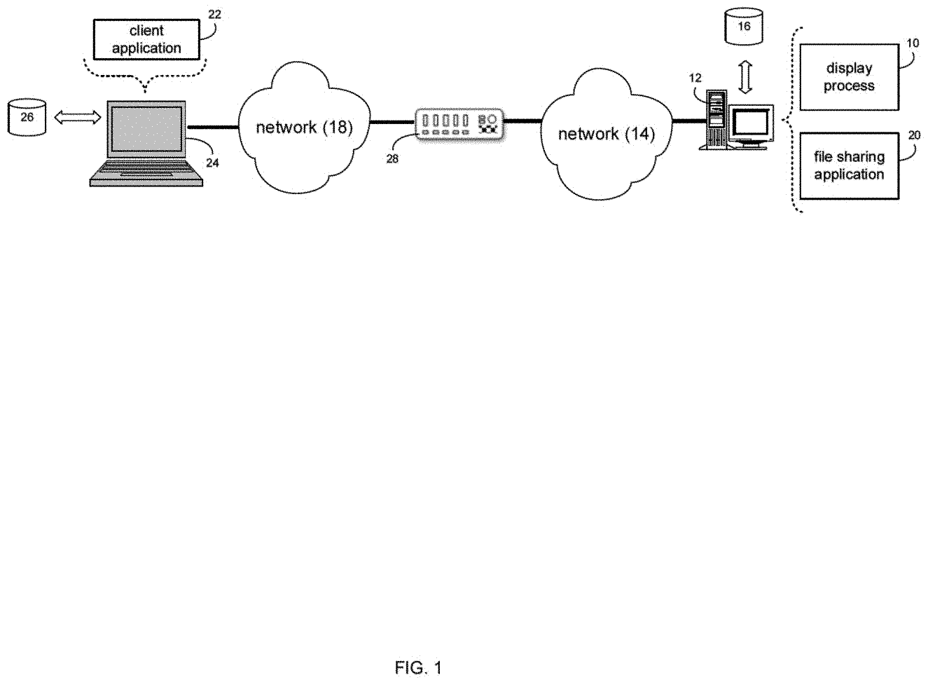

Referring now to the example implementation of FIG. 1, there is shown display process 10 that may reside on and may be executed by a computer (e.g., one or more remote machines also referred to as computer 12), which may be connected to a network (e.g., network 14) (e.g., the internet or a local area network). In some implementations, the instruction sets and subroutines of display process 10, which may be stored on storage device, such as storage device 16, coupled to computer 12, may be executed by one or more processors and one or more memory architectures included within computer 12. In some implementations, display process 10 may be a component of a data store, a standalone application that interfaces with the above noted data store and/or an applet/application that is accessed via client application 22. In some implementations, the above noted data store may be, in whole or in part, distributed in a cloud computing topology. In this way, computer 12 and storage device 16 may refer to multiple devices, which may also be distributed throughout the network. Computer 12 (e.g., via display process 10) may execute, operate or otherwise provide an application that may be any one of the following: software; a program; executable instructions; a virtual machine; a hypervisor; a web browser; a web-based client; a client-server application; a thin-client computing client; an ActiveX control; a Java® applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. In some implementations, display process 10 and/or file sharing application 20 may be accessed via one or more of client applications to facilitate the transfer of data and/or information among computer 12 and client electronic device 24 via network 14 and/or network 18. Client electronic device 24 (and/or computer 12) may include, but are not limited to, a personal computer, a mobile computing device such as a laptop computer, a smart/data-enabled, cellular phone, a notebook computer, and a tablet, a television, a smart speaker, an Internet of Things (IoT) device, a media (e.g., audio/video, photo, etc.) capturing and/or output device, an audio input and/or recording device (e.g., a microphone), a storage system (e.g., a Network Attached Storage (NAS) system, a Storage Area Network (SAN)), a server computer (e.g., a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality), a series of server computers, a server farm/datacenter, a mainframe computer, a computing cloud, or any other network enabled device. In some implementations, each of the aforementioned may be generally described as a computing device, and may also be referred to as a local machine, a client, a client node, a client computer, a client device, a client electronic device, a computing device, a computer, an endpoint, or an endpoint node, herein referred to as either a client electronic device or a computer. In some implementations, the client electronic devices may have the capacity to function as both a client node seeking access to resources provided by computer 12, and as computer 12 providing access to hosted resources for other client electronic devices.

In certain implementations, the client electronic devices and/or computer 12 may be a physical or virtual device. In many implementations, the client electronic devices and/or computer 12 may be any device capable of performing operations, such as a dedicated processor, a portion of a processor, a virtual processor, a portion of a virtual processor, portion of a virtual device, or a virtual device. In some implementations, a processor may be a physical processor or a virtual processor. The client electronic devices and/or computer 12 may be a virtual machine that may provide to a user of the client electronic device access to a computing environment. The virtual machine may be managed by, for example, a hypervisor, a virtual machine manager (VMM), or any other hardware virtualization technique. In some implementations, a virtual processor may correspond to one or more parts of one or more physical processors. In some implementations, the instructions/logic may be distributed and executed across one or more processors, virtual or physical, to execute the instructions/logic. The client electronic devices and/or computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the client electronic devices and/or computer 12 may include storage devices (e.g., storage device 16, 26) such as: an electrical connection having one or more wires; a portable computer diskette; a hard disk drive; all forms of flash memory storage devices including an erasable programmable read-only memory (EPROM); a tape drive; an optical drive/fiber; a Redundant Array of Independent Disks (RAID) array (or other array); a random access memory (RAM); a read-only memory (ROM); a portable compact disc read-only memory (CD-ROM); a digital versatile disk (DVD); a static random access memory (SRAM); a memory stick; a floppy disk; a mechanically encoded device; a media such as those supporting the internet or an intranet; a magnetic storage device; or combination thereof. In some implementations, the client electronic devices and/or computer 12 may include a data store, such as a database (e.g., relational database, object-oriented database, triplestore database, etc.) and may be located within any suitable memory location (e.g., storage device 16 coupled to computer 12). In some implementations, the storage devices may be communicatively coupled to the client electronic devices and/or computer 12 to store data, metadata, or other information to facilities operation of the present disclosure.

In some implementations, the client electronic devices and/or computer 12 may be communicatively coupled to the data store so that data, metadata, information, etc. described throughout the present disclosure may be stored and accessed. In some implementations, the client electronic devices and/or computer 12 may utilize any known database management system in order to provide multi-user access to one or more databases, such as the above noted relational database. In some implementations, the data store may also be a custom database, such as, for example, a flat file database or an XML database. In some implementations, any other form(s) of a data storage structure and/or organization may also be used.

In some implementations, computer 12 may execute a file sharing application (e.g., file sharing application 20), examples of which may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, a remote presentation services program or other program that uses a thin-client or a remote-display protocol to capture display output generated by an application executing on computer 12 and transmit the application display output to the client electronic device, or other application that allows for file sharing or even the general viewing of any content (e.g., website content, streaming video games or movies, etc.) on a computing device. An example of file sharing application 20 may include, but is not limited to, e.g., ShareFile® by Citrix Systems, Inc. of Ft. Lauderdale, Fla.

In some implementations, display process 10 may be a standalone application, or may be an applet/application/script/extension that may interact with and/or be executed within file sharing application 20, a component of file sharing application 20, and/or one or more of the client applications. In some implementations, file sharing application 20 may be a standalone application, or may be an applet/application/script/extension that may interact with and/or be executed within display process 10, a component of display process 10, and/or one or more of the client applications. In some implementations, one or more of the client applications may be a standalone application, or may be an applet/application/script/extension that may interact with and/or be executed within and/or be a component of display process 10 and/or file sharing application 20. Examples of client applications may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, a remote presentation services program or other program that uses a thin-client or a remote-display protocol to capture display output generated by an application executing on computer 12 and transmit the application display output to the client electronic device, or other application that allows for file sharing or even the general viewing of any content (e.g., website content, streaming video games or movies, etc.) on a computing device, a standard and/or mobile web browser, an email application (e.g., an email client application), a textual and/or a graphical user interface, a customized web browser, a plugin, an Application Programming Interface (API), or a custom application. The instruction sets and subroutines of client application 22, which may be stored on storage device 26, coupled to client electronic device 24, may be executed by one or more processors and one or more memory architectures incorporated into client electronic device 24.

In some implementations, one or more of the client applications may be configured to effectuate some or all of the functionality of display process 10 (and vice versa). Accordingly, in some implementations, display process 10 may be a purely server-side application, a purely client-side application, or a hybrid server-side/client-side application that is cooperatively executed by one or more of the client applications and/or display process 10.

In some implementations, one or more of the client applications may be configured to effectuate some or all of the functionality of file sharing application 20 (and vice versa). Accordingly, in some implementations, file sharing application 20 may be a purely server-side application, a purely client-side application, or a hybrid server-side/client-side application that is cooperatively executed by one or more of the client applications and/or file sharing application 20. As one or more of the client applications, display process 10, and file sharing application 20, taken singly or in any combination, may effectuate some or all of the same functionality, any description of effectuating such functionality via one or more of the client applications, display process 10, file sharing application 20, or combination thereof, and any described interaction(s) between one or more of the client applications, display process 10, file sharing application 20, or combination thereof to effectuate such functionality, should be taken as an example only and not to limit the scope of the disclosure.

In some implementations, one or more of users may access computer 12 and display process 10 (e.g., using one or more of client electronic devices) directly through network 14 or through secondary network 18, and display process 10 may include one or more user interfaces, such as browsers and textual or graphical user interfaces, through which users may access display process 10. Further, computer 12 may be connected to network 14 through secondary network 18. In some implementations, the client electronic devices may communicate with computer 12 (and vice versa) via intermediary appliance (e.g., appliance 28), which in some implementations may include display process 10. Appliance 28 may be positioned between networks 14 and 18, and may also be referred to as a network interface or gateway. In some implementations, appliance 28 may operate as an application delivery controller (ADC) to provide users with access to business applications and other data deployed in a datacenter, a cloud environment, or delivered as Software as a Service (SaaS) across a range of computing devices, and/or provide other functionality such as load balancing, etc. In some implementations, multiple appliances may be used, and appliance(s) 28 may be deployed as part of network 14 and/or 18.

In some implementations, one or more client electronic devices and/or computer 12 may be directly or indirectly coupled to networks 14 and/or 18 via a network connection (e.g., a wireless or a hardwired network connection). Further, in some examples, a wireless communication connection may include a wireless access point (WAP). The wireless access point may be, for example, an IEEE 802.11a, 802.11b, 802.11g, 802.11n, 802.11ac, Wi-Fi®, RFID, and/or Bluetooth™ (e.g., 802.15) (including Bluetooth™ Low Energy) device that is capable of establishing wireless communication channel (e.g., between client electronic device 24 and the WAP). In some examples, the client electronic devices and/or computer 12 may be wirelessly coupled to a network via wireless communication channel using cellular network/bridge.

In some implementations, networks 14 and/or 18 may include and/or be connected to one or more secondary networks, examples of which may include but are not limited to: a local area network (LAN); a personal area network (PAN); a metropolitan area network (MAN); a wide area network (WAN) or other telecommunications network facility, a primary public network; a primary private network; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of wireless local-area network (WLAN) interconnection (e.g., Near Field Communication (NFC)) may also be used.

In some implementations, various I/O requests may be sent from, e.g., client application 22 to, e.g., computer 12 (and vice versa) using network 14 and/or 18. Examples of an I/O request may include but are not limited to, data write requests (e.g., a request that content be written to computer 12) and data read requests (e.g., a request that content be read from computer 12).

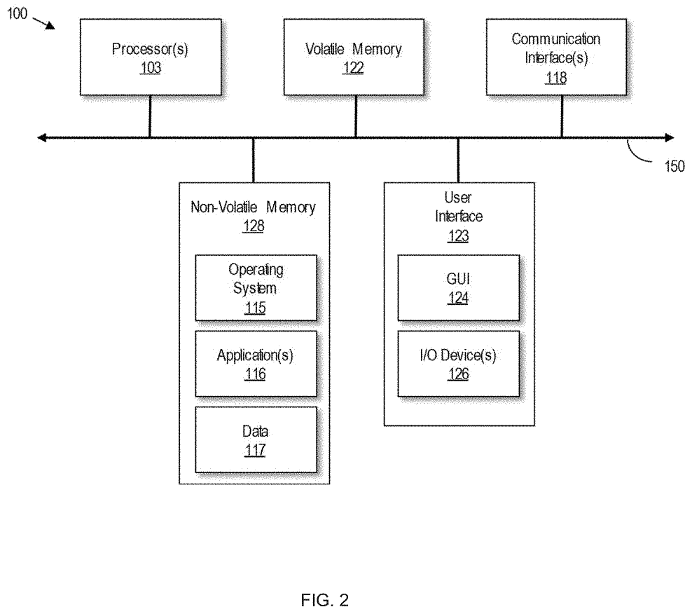

Referring also to the example implementation of FIG. 2, there is shown a block diagram of computing device 100 that may be useful for practicing an implementation of the client electronic devices, appliance 28 and/or computer 12. computing device 100 may include one or more processors 103, volatile memory 122 (e.g., random access memory (RAM)), non-volatile memory 128, user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

UI 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 may store operating system 115, one or more applications 116, and data 117 such that, for example, computer instructions of operating system 115 and/or applications 116 are executed by processor(s) 103 out of volatile memory 122. In some implementations, volatile memory 122 may include one or more types of RAM and/or a cache memory that may offer a faster response time than a main memory. Data may be entered using an input device of GUI 124 or received from I/O device(s) 126. Various elements of computer 100 may communicate via communications bus 150.

Computing device 100 is shown merely as an example client electronic device or server, and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” may describe circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some implementations, the processor may be embodied in one or more application specific integrated circuits (ASICs), microprocessors, digital signal processors (DSPs), graphics processing units (GPUs), microcontrollers, field programmable gate arrays (FPGAs) or other hardware accelerators, micro-controller units (MCUs), programmable logic arrays (PLAs), multi-core processors, or general-purpose computers with associated memory.

Processor 103 may be analog, digital or mixed-signal. In some implementations, processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network (e.g., network 14 and/or 18 of FIG. 1) such as a Local Area Network (LAN), a Wide Area Network (WAN), a Body Area Network (BAN), a Personal Area Network (PAN), a Metropolitan Area Network (MAN), or the Internet through a variety of wired and/or wireless connections, including cellular connections.

In described implementations, computing device 100 may execute an application (e.g., the above-noted client application) on behalf of a user of a client electronic device. For example, computing device 100 may execute one or more virtual machines managed by a hypervisor. Each virtual machine may provide an execution session within which applications execute on behalf of a user or a client electronic device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

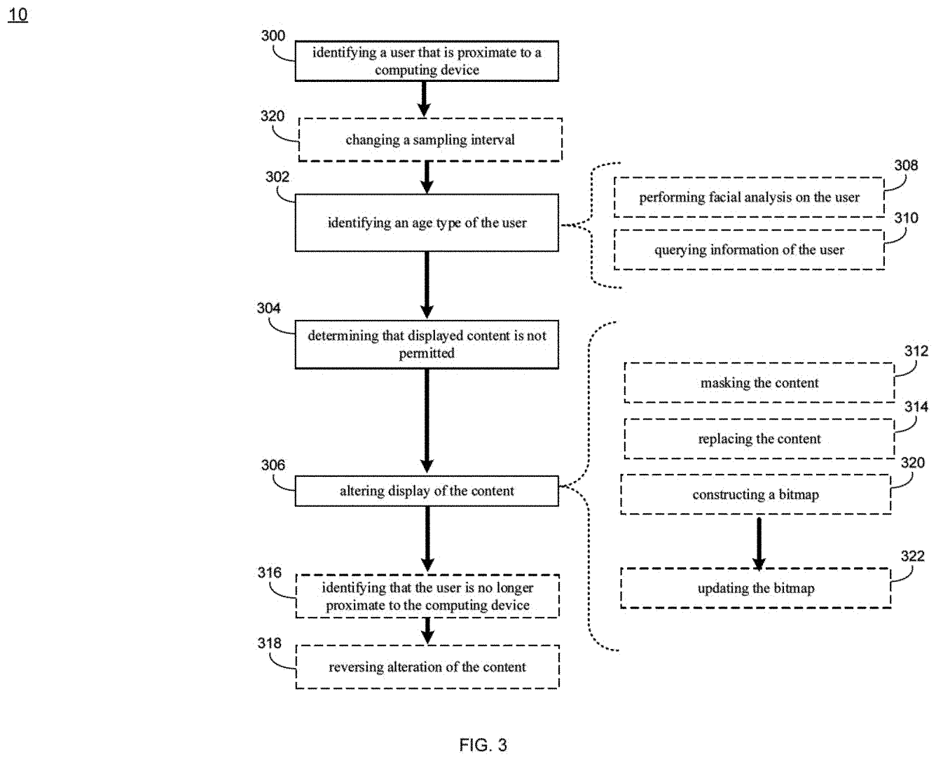

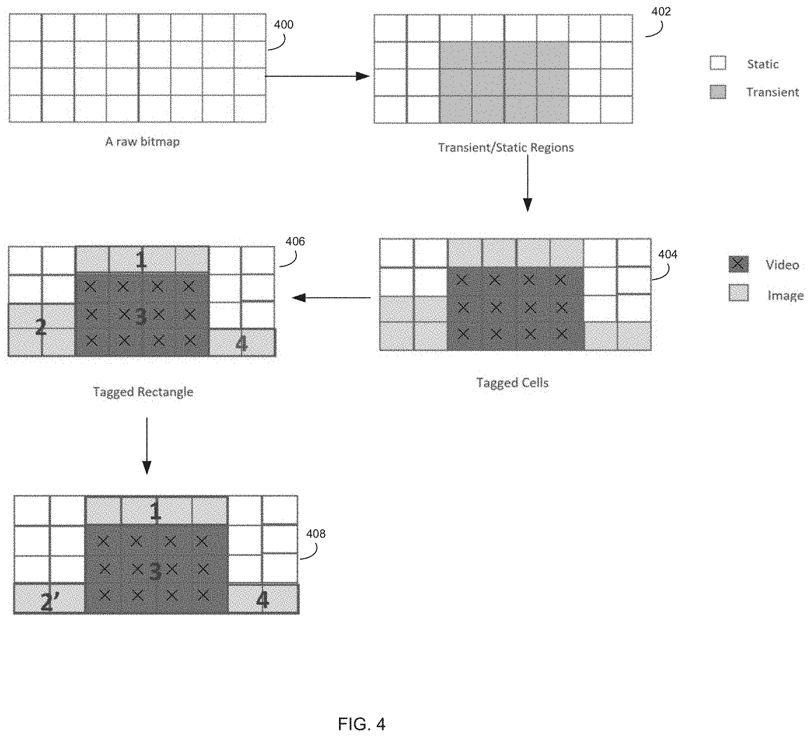

As discussed above and referring also at least to the example implementations of FIGS. 3-4, at block 300, display process 10 may identify a user that is proximate to a computing device (e.g., client electronic device 42 of FIG. 1). At block 302, display process 10 may identify the age type of the user. At block 304, display process 10 may determine that content displayed on the computing device is not permitted for the age type of the user. At block 306, display process 10 may alter display of the content on the computing device based upon, at least in part, determining that the content displayed on the computing device is not permitted for the age type of the user.

As will be discussed below, in some implementations, display process 10 may include, e.g., a) user discovery and age estimation, b) image analysis and protection, and c) image classification. As such, display process 10 may (e.g., in real-time) help ensure that only age appropriate content is displayed based upon who is viewing the content. For example, in some implementations, at block 300, display process 10 may identify a user that is proximate to a computing device (e.g., client electronic device 24 of FIG. 1). For instance, assume for example purposes only that client electronic device 24 includes a visual input component (e.g., a camera). In the example, display process 10 may use the camera to identify that a user (e.g., user 48) is proximate client electronic device 24 (e.g., has come into view of the camera), and may be therefore capable of viewing the content displayed on client electronic device 24.

In some implementations, at block 302, display process 10 may identify the age type of the user. For instance, to help ensure that user 48 is not viewing age-inappropriate images, videos, games, etc., on client electronic device 24, display process 10 may need to identify the age type of user 48. For example, as will be discussed below, the identified age type may be based upon user biometric features to estimate/verify the user's age, which may be used to classify user 48 into an age type as either a minor (e.g., under 18 years of age) or as an adult (e.g., 18 years of age or older). In some implementations, the age type may be segregated into more granular age types or ranges (e.g., between ages 1-12, 13-17, 18+, etc.), however, it will be appreciated that other age types/classifications may be used without departing from the scope of the disclosure.

In some implementations, at optional block 308, identifying the age type of the user may include performing facial analysis on the user. For example, display process 10 may include facial recognition technology (e.g., a facial recognition API) that may detect one or more human faces (such as user 48) in an image obtained from the above-noted camera. In some implementations, facial detection and recognition may identify where a face is located in the image, which may then be analyzed using, e.g., a regression algorithm with continuous age algorithm (i.e., a single estimated age) or a multi-classification algorithm with different age ranges, such as those noted above.

In some implementations, at optional block 310, identifying the age type of the user may include querying information of the user from a storage device. For example, as an alternative (or in addition) to using resources to estimate the age of user 48, display process 10 may use the facial recognition to determine the identity of user 48, and may query user information (e.g., from local or remote storage). For instance, user 48 may have a stored user profile that already includes the birthday and/or age of user 48. Thus, in the example, display process 10 may use facial recognition to identify that it is user 48 that is proximate to client electronic device 24, and then query the age related information in the user profile associated with user 48 to identify the age type and/or age type of user 48. In some implementations, display process 10 may create a new user profile the first time a new user is detected (e.g., save age information for users who are identified in a certain time frame, such as the last 24 hours, to avoid frequent and unnecessary age estimation), and in some implementations, the user profile may be created manually (e.g., prior to the first time user detection).

In some implementations, at block 304, display process 10 may determine that content displayed on the computing device is not permitted for the age type of the user. For instance, assume for example purposes only that the content currently being displayed would be inappropriate for a minor. Continuing with the above example where display process 10 has identified that user 48 is proximate to client electronic device 24 (and therefore capable of viewing the displayed content), and has further identified the age type of user 48 as a minor, because the content currently being displayed would be inappropriate for a minor (or other identified age type under the age of 18), and because user 48 has been identified as a minor, display process 10 may determine the content is not permitted for user 48. Conversely, if the content currently being displayed would be inappropriate for a minor, and if user 48 has been identified as an adult, display process 10 may determine the content is permitted for user 48.

In some implementations, image classification methods used to determine what is being displayed may include, e.g., Linear Classifiers, Linear Discriminant Analysis (LDA), Logistic Regression, Naïve Bayes Classifiers, as well as Support Vector Machine (SVM), Convolutional Neural Networks (CNNs), etc. In some implementations, display process 10 may create a new CNN, and/or tailor an existing CNN and re-train the model with new datasets for age-inappropriate content. For example, display process 10 may build an age-inappropriate dataset, and split it into a training set and validation set, select a CNN network as a base, replace the last fully connected layer to support image classification types (e.g., sexual image, violent image, advertisement, cyber game, etc.) and retrain the model to tune network parameter and hyper-parameters. While most image classification algorithms require a significant computational cost due to the larger number of operations involved, although not required, the present disclosure may mitigate these costs by, e.g., running the image classification on the server side from either on premise or cloud computing environment, and by only having a few image classification types supported. In some implementations, known rating systems (e.g., G, PG-13, Mature Audiences, etc.) assigned to content ahead of time may also be used to determine whether the content being displayed is permitted for a particular age type.

In some implementations, at block 306, display process 10 may alter display of the content on client electronic device 24 based upon, at least in part, determining that the content displayed on the computing device is not permitted for the age type of the user. For instance, and continuing with the above example, because the content currently being displayed would be inappropriate for a minor, and because user 48 has been identified as a minor, display process 10 may determine the content is not permitted for user 48. Thus, in the example, display process 10 alter display of the content to ensure that user 48 is not viewing age-inappropriate material.

For instance, in some implementations, at optional blocks 312, 314, 320, and 322 respectively, altering display of the content may include one of masking the content and replacing the content, constructing a bitmap with a size equal to coordinates of at least a portion of the content displayed, and updating the bitmap at the coordinates of at least the portion of the content displayed to alter the display. For masking, assume for example purposes only that the content being displayed is a cyber-game, an age-inappropriate image or video frame. In the example, as will be discussed below, display process 10 may construct a bitmap, like a solid color or mosaic, with a size equal to the target (e.g., rectangle) of where the inappropriate content is being displayed, and then update the bitmap to the corresponding coordinates of the user screen. For replacement, assume for example purposes only that the content being displayed is an adult advertisement. In the example, as will be discussed below, display process 10 may construct a bitmap filled with child-friendly (or otherwise age-appropriate) advertisement content, with a size equal to the target (e.g., rectangle) of where the adult advertisement is being displayed, and then update the bitmap to the corresponding coordinates of the user screen. In some implementations, the entire display screen, rather than only the age-inappropriate content, may be masked or replaced.

In some implementations, on-screen bitmap analysis of display process 10 may be used to locate on-screen areas that are static or transient imagery, which potentially contain the mentioned harmful (age-inappropriate) content for minors. Display process 10 may then send their coordinates for image classification (discussed above) to make a judgement as to whether the content is age-inappropriate. In some implementations, initially, the bitmap may be split into a batch of, e.g., 16*16 small cells which may be merged by adjacent cells into big regions based on whether the content is transient or static. An example of a raw bitmap 400 and transient/static regions of bitmap 402 are shown in example FIG. 4. Regions in a given bitmap that meet the example and non-limiting attributes noted below may be identified as transient, and a transient region may be treated as video area:

Contains less than 30% of cache drawn rectangles;

Is updated with a certain frequency, like >=10 FPS;

Is larger than a transient minimum area, like 10,000 pixels; and

Relative position is not changed compared with previous frames.

Display process 10 may continue to differentiate image regions from the other static regions (as shown in bitmap 404 in FIG. 4) based on whether a cell is a lossless text or not. Differences in pixel values on each cell may be scanned, and if the cell contains a majority of large changes, the cell may be assumed to be lossless text. Referring to bitmap 406 in FIG. 4, display process 10 may compose cells relevant to the image and video with the same tag as a rectangle which may be represented as, e.g., “Rectangle ID: position parameters {x,y}, width, height) and candidate tag”. Here, (x,y) stands for absolute coordinate of left-top vertex, relative to the whole screen. For example, Rectangle 1: {(32,0),64,16,“image”}; Rectangle 3: {(32,16),64,48,“video”}; and so on. Each tagged rectangle is the candidate bitmap to be processed by image classification. The relationship across tagged rectangles may be generally named “Image Layout”. Referring to bitmap 408 in FIG. 4, the content update may not always force a rebuild of the image layout. However, sometimes the rectangle may have to be split based on the latest content tag and then merge the sub-rectangles with adjacent ones (e.g., when the content updates, the first two cells in rectangle 2 are no longer image tagged), thus, rebuilding the new image layout as below. In other words, once the layout change happens to a specific rectangle, display process 10 may consider how to merge with the adjacent rectangles for the maximum rectangle coverage by the same tag.

As such, display process 10 may perform image analysis and protection by, e.g., checking the screen as a bitmap, re-calculating the image layout, and sending all rectangle bitmaps with video or image tags (e.g., rectangle 1, 2, 3, 4) for image classification when a user is newly identified as being proximate to the client electronic device, and may only send tagged rectangle bitmaps (e.g., rectangle 3, 4 with content changes) with content refresh if neither layout changes nor a user is newly identified as being proximate to the client electronic device, and may only send position impacted rectangle bitmaps (e.g., rectangle 2′ with position changes) if the layout change happens but no new user is identified as being proximate to the client electronic device.

In some implementations, at optional block 316, display process 10 may identify that the user is no longer proximate to client electronic device 24, and at optional block 318, display process 10 may reverse alteration of the content displayed on client electronic device 24, based upon, at least in part, identifying that the user is no longer proximate to client electronic device 24. For example, similar to how display process 10 may identify that user 48 is proximate to client electronic device 24, display process 10 may identify that user 48 is no longer proximate to client electronic device 24 (e.g., user 48 no longer appears in the camera due to user 48 having left the room or is no longer able to view the content being displayed). In some implementations, when user 48 is no longer proximate to client electronic device 24 (and no other users are identified as proximate to client electronic device 24 identified with an age type not permitted to view the displayed content), the on-screen bitmap analysis and harmful content masking/replacing may pause, and the original screen content may be presented for viewing by those users identified with an age type permitted to view the displayed content.

In some implementations, display process 10 may, at optional block 320 display process 10 may change a sampling interval based upon, at least in part, identifying that the user that is proximate to client electronic device 24. For example, in some implementations, display process 10 may track user movement in camera view by using a local binary patterns (LBP) algorithm, and may only request age estimation for newly detected users every sampling interval. Generally, LBP is a light weighted facial detection and recognition algorithm with few computational resources that may track user movement and detect any more or less users in camera view. When neither a new minor arrives nor existing minor leaves, no additional facial age estimation needs to occur. In other word, display process 10 need not be concerned about the frequent and instant user changes in the front of screen until the next sampling point. Thus, to save on resources, display process 10 may dynamically increase the sampling interval (e.g., every 5 seconds) when users are identified with an age type not permitted to view the displayed content and dynamically decrease the sampling interval (e.g., every 1-2 seconds) when only users are identified with an age type permitted to view the displayed content.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code or machine code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network (BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted as optional). For example, two blocks shown in succession may, in fact, be executed substantially concurrently, or the blocks may sometimes be executed in the reverse order or not at all, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method comprising:
identifying a user that is proximate to a computing device;
identifying an age type of the user;
determining that content displayed on the computing device is not permitted for the age type of the user; and
altering display of the content on the computing device based upon, at least in part, determining that the content displayed on the computing device is not permitted for the age type of the user.

2. The method of claim 1 wherein altering display of the content includes one of masking the content and replacing the content.

3. The method of claim 1 further comprising:
identifying that the user is no longer proximate to the computing device; and
reversing alteration of the content displayed on the computing device based upon, at least in part, identifying that the user is no longer proximate to the computing device.

4. The method of claim 1 further comprising changing a sampling interval based upon, at least in part, identifying that the user that is proximate to the computing device.

5. The method of claim 1 further comprising constructing a bitmap with a size equal to coordinates of at least a portion of the content displayed.

6. The method of claim 5 further comprising updating the bitmap at the coordinates of at least the portion of the content displayed to alter the display.

7. The method of claim 1 wherein identifying the age type of the user includes performing facial analysis on the user.

8. A computer program product residing on a computer readable storage medium having a plurality of instructions stored thereon which, when executed by one or more processors, causes the one or more processors to perform operations comprising:
identifying a user that is proximate to a computing device;
identifying an age type of the user;
determining that content displayed on the computing device is not permitted for the age type of the user; and
altering display of the content on the computing device based upon, at least in part, determining that the content displayed on the computing device is not permitted for the age type of the user.

9. The computer program product of claim 8 wherein altering display of the content includes one of masking the content and replacing the content.

10. The computer program product of claim 8 wherein the operations further comprise:
identifying that the user is no longer proximate to the computing device; and
reversing alteration of the content displayed on the computing device based upon, at least in part, identifying that the user is no longer proximate to the computing device.

11. The computer program product of claim 8 wherein the operations further comprise changing a sampling interval based upon, at least in part, identifying that the user that is proximate to the computing device.

12. The computer program product of claim 8 further comprising constructing a bitmap with a size equal to coordinates of at least a portion of the content displayed.

13. The computer program product of claim 8 further comprising updating the bitmap at the coordinates of at least the portion of the content displayed to alter the display.

14. The computer program product of claim 8 wherein identifying the age type of the user includes performing facial analysis on the user.

15. A computing system comprising:
a memory; and
at least one processor in communication with the memory, the at least one processor configured to:
identify a user that is proximate to a computing device;
identify an age type of the user;
determine that content displayed on the computing device is not permitted for the age type of the user; and
alter display of the content on the computing device based upon, at least in part, determining that the content displayed on the computing device is not permitted for the age type of the user.

16. The computing system of claim 15 wherein altering display of the content includes one of masking the content and replacing the content.

17. The computing system of claim 15 wherein the processor is further configured to:
identify that the user is no longer proximate to the computing device; and
reverse alteration of the content displayed on the computing device based upon, at least in part, identifying that the user is no longer proximate to the computing device.

18. The computing system of claim 15 wherein the processor is further configured to change a sampling interval based upon, at least in part, identifying that the user that is proximate to the computing device.

19. The computing system of claim 15 further comprising constructing a bitmap with a size equal to coordinates of at least a portion of the content displayed and updating the bitmap at the coordinates of at least the portion of the content displayed to alter the display.

20. The computing system of claim 15 wherein identifying the age type of the user includes performing facial analysis on the user.
